(19) United States
(12) Patent Application Publication
(10) Pub. No.: US 2015/0270086 A1
(43) Pub. Date: Sep. 24, 2015

(54) SURGE PROTECTOR WITH SAFETY MECHANISM

(71) Applicant: Tsan-Chi CHEN, New Taipei City (TW)

(72) Inventor: Tsan-Chi CHEN, New Taipei City (TW)

(21) Appl. No.: 14/313,573

(22) Filed: Jun. 24, 2014

(30) Foreign Application Priority Data
Mar. 20, 2014 (TW) 103110445

(51) Int. Cl. H01H 85/04; H01H 85/20

(52) U.S. Cl. CPC H01H 85/04; H01H 85/20

(57) ABSTRACT

The present invention is to provide a surge protector with a safety mechanism, which comprises a dielectric element made of a polycrystalline semiconductor ceramic material and having two opposite sides each attached with an electrode; two conductive plates each having a portion adjacent to one end thereof and attached to one of the electrodes via surface contact, an opposite end serving as a pin for electrically connecting with a power supply, and a middle section between the two ends and having a smaller cross-sectional area than other sections thereof; and an insulating enclosure enclosing the dielectric element and the conductive plates in such a way that the middle sections are enclosed and that only the pins are exposed from the insulating enclosure. Thus, when subjected to a large current generating a high temperature exceeding a predetermined threshold value, the middle section melts and breaks to provide a fuse-like safety mechanism.

### FIELD OF THE INVENTION

The present invention relates to a surge protector, more particularly to a surge protector with a safety mechanism, which comprises a dielectric element having two opposite sides each attached with an electrode, two conductive plates each having one end attached to one of the electrodes and an opposite end serving as a pin for electrically connecting with a power supply and a middle section having a smaller cross-sectional area than other sections thereof, and an insulating enclosure enclosing the dielectric element and the conductive plates in such a way that the middle sections are enclosed and that only the pins are exposed from the insulating enclosure. Thus, when subjected to a large current generating a high temperature exceeding a predetermined threshold value, the middle section melts and breaks to provide a fuse-like safety mechanism.

### BACKGROUND OF THE INVENTION

Most electronic apparatuses are subject to the impact of surges during operation and may be damaged as a result. The so-called “surges” are also known as “voltage (or current) spikes” and can be divided by source into “surges generated outside a circuit” and “surges generated within a circuit”. Generally speaking, the former is caused by lightning either taking place around an electronic apparatus or directly striking a circuit of the electronic apparatus and is hence called lightning surges. The latter often accompanies the switching of an electronic switch in an electronic apparatus and is therefore also referred to as switching surges.

If an electronic apparatus is provided with a switching element such as a relay, an electronic switch, or a solenoid, the switching element is very likely to be turned on and off a great number of times during operation of the electronic apparatus in order to close and open a circuit, thus generating a lot of surges, which may have undesirable effects on the operation of the electronic apparatus and give rise to false actions, for example. One conventional solution is to install a surge protector at the power supply end of the electronic apparatus. The surge protector forms a discharge path upon occurrence of a surge and guides the surge to a ground end through the discharge path, thereby protecting the electronic apparatus from damage which may otherwise result from the surge.

Metal oxide varistors (MOVs) are dielectric elements traditionally used in surge protectors. An MOV is a polycrystalline semiconductor ceramic element made typically by sintering zinc oxide grains with a small amount of other metal oxides or polymers. Within such an MOV, there are a vast amount of disorderly zinc oxide grains, and the boundaries between the zinc oxide grains and the other metal oxides form boundary layers where diode effects occur. Therefore, the entire MOV is equivalent to an aggregate of a large number of diodes connected back to back. When the MOV is subjected to a low voltage, only a small reverse leak current flows through the MOV, but when a high voltage is applied to the MOV, the punch-through effect takes place, allowing the large current of the high voltage to pass through the MOV. The main reason why MOVs are extensively used in making surge protectors lies in their non-linear current-voltage characteristic curves, in which electrical resistance is high under a low voltage and low under a high voltage.

While surge discharge can be achieved using the aforesaid surge protectors, a long-term observation and research by the inventor of the present invention reveals the various design drawbacks of the conventional surge protectors.

FIG. 1 and FIG. 2 show a conventional surge protector 1 commonly found in the market. The conventional surge protector 1 includes a dielectric element 10, a first wire (or conductive plate) 120, a second wire (or conductive plate) 121, and an insulating enclosure 13. The dielectric element 10 is a plate made of the aforementioned polycrystalline semiconductor ceramic material. The two opposite sides of the dielectric element 10 are attached with a first electrode 110 and a second electrode 111 respectively. A portion of the first wire 120 that is adjacent to one end thereof is fixed to the first electrode 110 by soldering while the other end of the first wire 120 serves as a first pin 1201 for electrically connecting with the power supply end of an electronic apparatus (not shown) Similarly, a portion of the second wire 121 that is adjacent to one end thereof is soldered to the second electrode 111 while the other end of the second wire 121 serves as a second pin 1211 for electrically connecting with the power supply end of the electronic apparatus. The insulating enclosure 13 encloses the dielectric element 10, the first wire 120, and the second wire 121 in such a way that only the first pin 1201 and the second pin 1211 are exposed from the insulating enclosure 13.

In the conventional surge protector 1, each of the wires 120 and 121 is connected to the dielectric element 10 by “line contact”. Therefore, due to the limited soldered areas, the connection between the dielectric element 10 and each of the wires 120 and 121 is very likely to break when subjected to an extremely large voltage and current. As the voltage and current that the dielectric element 10 has to withstand per unit area are also of very great magnitude, a high transient voltage passing through the dielectric element 10 tends to make through holes in the resistor body of the dielectric element 10, allowing passage of even larger transient currents, which may result in electric arcs and consequently high heat or fire. Even if the conventional surge protector 1 survives the impacts of large currents many times without transient breakage or burning, studies show that the excessively high temperatures of those impacts must have accelerated the aging of the dielectric element 10. Gradually, the dielectric element 10 will experience linearization of the low resistance range and form weak points. Once large leak currents take place more frequently and flow to the weak points in a concentrated manner, the weak points may melt and become short-circuit holes. Should large currents gush into the short-circuit holes, high heat is bound to occur and may set fire to the conventional surge protector 1.

Hence, referring to FIG. 3, when installing the conventional surge protector 1 to the power supply end Vi of an electronic apparatus 2, it is common practice to connect the conventional surge protector 1 in parallel between the power supply end Vi and the circuit of the electronic apparatus 2 and connect a safety element (e.g., a fuse) 3 in series to one of the power supply pins of the conventional surge protector 1. If the connection between the dielectric element 10 and either wire 120, 121 breaks, or if through holes are formed in the resistor body of the dielectric element 10, the safety element 3 can be melted by the high temperature generated by a large transient current passing therethrough and form an open circuit. Thus, fire which may otherwise result from sustained power supply is prevented, and the electronic apparatus is protected from damage.

However, the safety element 3 not only adds to the production cost, but also takes up a certain amount of circuit space while increasing the complexity of circuitry. In fact, the safety element 3 has become a major factor that hinders the downsizing of related circuits. As a solution, referring to FIG. 4, the conventional surge protector 1 shown in FIG. 1 and FIG. 2 is additionally provided with a temperature-sensitive safety element (e.g., a thermal fuse) 14. One end 141 of the temperature-sensitive safety element 14 is soldered to the first electrode 110 and is enclosed in the insulating enclosure 13 together with the dielectric element 10, the first wire 120, and the second wire 121. Only the first pin 1201, the second pin 1211, and the other end 142 of the temperature-sensitive safety element 14 are exposed from the insulating enclosure 13. When sensing that the temperature of the first electrode 110 exceeds a predetermined threshold value, the temperature-sensitive safety element 14 enters an open-circuit state to prevent sustained supply of electricity from the power supply end. Nevertheless, this solution incurs the additional cost of the temperature-sensitive safety element 14 and increases the volume of the conventional surge protector 1 and the space occupied thereby. Moreover, the circuit of the conventional surge protector 1 is complicated because it must be designed to terminate power supply at an appropriate time after the temperature-sensitive safety element 14 forms an open circuit.

The issue to be addressed by the present invention, therefore, is to design a structurally simple and low-cost surge protector which, in addition to surge protection, provides the function of a safety element but is in fact free of any extra safety elements. It is desirable that the surge protector forms an open circuit when the connection between the dielectric element 10 and either wire 120, 121 breaks or when through holes are formed in the resistor body of the dielectric element 10. The ultimate goal is to effectively prevent the aforesaid burning incidents and protect electronic apparatuses from damage.

### BRIEF SUMMARY OF THE INVENTION

In view of the aforementioned drawbacks of the conventional surge protectors, the inventor of the present invention incorporated years of practical experience in the related industry into designing and repeated experiments and finally succeeded in developing a surge protector with a safety mechanism as disclosed herein. The present invention substantially increases the safety of surge protectors and hence effectively ensures the safety of use of electronic apparatuses.

It is an objective of the present invention to provide a surge protector having a safety mechanism. The surge protector includes a dielectric element, a first conductive plate, a second conductive plate, and an insulating enclosure. The dielectric element is a plate made of a polycrystalline semiconductor ceramic material. The two opposite sides of the dielectric element are attached with a first electrode and a second electrode respectively. The first conductive plate has a portion which is adjacent to one end (hereinafter referred to as the first end) of the first conductive plate and which is attached to the first electrode by surface contact. The opposite end of the first conductive plate forms a first pin and serves to electrically connect with the power supply end of an electronic apparatus. The first conductive plate further has a middle section which is between the two ends of the first conductive plate and which has a smaller cross-sectional area than the other sections of the first conductive plate. This middle section provides a fuse-like mechanism because it melts and breaks rapidly when subjected to a large current which generates a high temperature exceeding a predetermined threshold value. Similarly, the second conductive plate has a portion which is adjacent to one end (hereinafter referred to as the first end) of the second conductive plate and which is attached to the second electrode by surface contact. The opposite end of the second conductive plate forms a second pin and serves to electrically connect with the power supply end of the electronic apparatus. The second conductive plate further has a middle section which is between the two ends of the second conductive plate and which has a smaller cross-sectional area than the other sections of the second conductive plate. This middle section provides a fuse-like mechanism because it melts and breaks rapidly when subjected to a large current which generates a high temperature exceeding a predetermined threshold value. The insulating enclosure encloses the dielectric element, the first conductive plate, and the second conductive plate in such a way that the middle sections of the first and the second conductive plates are enclosed and that only the first and the second pins are exposed from the insulating enclosure. When a rush current flows through the surge protector and the high voltage of the rush current causes the portion of either conductive plate that is adjacent to its first end to separate from the corresponding electrode, or when the high voltage punches through the dielectric element and causes an extremely large transient current to run through the surge protector and generate an extremely high temperature, the middle section of the conductive plate melts and breaks rapidly because of the large current and the high temperature generated thereby and forms an open circuit. Thus, fire attributable to continuous accumulation of heat in the surge protector is prevented, and the electronic apparatus or its electronic circuits or elements are effectively protected from damage.

Another objective of the present invention is to provide the foregoing surge protector, wherein the conductive plates are made of a conductive metal whose melting point is lower than and whose impedance is higher than those of copper. The conductive metal can be aluminum, silver, tin, zinc, or an alloy thereof, provided that a large current through the middle sections of the conductive plates can generate a high temperature at the middle sections due to their relatively small cross-sectional areas and thereby melt and break the middle sections rapidly, turning the middle sections into open circuits.

Still another objective of the present invention is to provide the foregoing surge protector, wherein the middle section of each conductive plate is formed with and penetrated by at least one slot in order to have a smaller cross-sectional area than the other sections of the same conductive plate.

Yet another objective of the present invention is to provide the foregoing surge protector, wherein the slot is formed within the middle section of each conductive plate in order for the middle sections to have relatively small cross-sectional areas in comparison with the other sections of the conductive plates.

A further objective of the present invention is to provide the foregoing surge protector, wherein the slot is formed at a lateral side of the middle section of each conductive plate in order for the middle sections to have relatively small cross-sectional areas in comparison with the other sections of the conductive plates.

### BRIEF DESCRIPTION OF THE SEVERAL VIEWS OF THE DRAWINGS

The objectives, as well as the technical features and their effects, of the present invention will be best understood by referring to the following detailed description of some illustrative embodiments in conjunction with the accompanying drawings, in which:

FIG. 1 is an exploded view of a conventional surge protector;

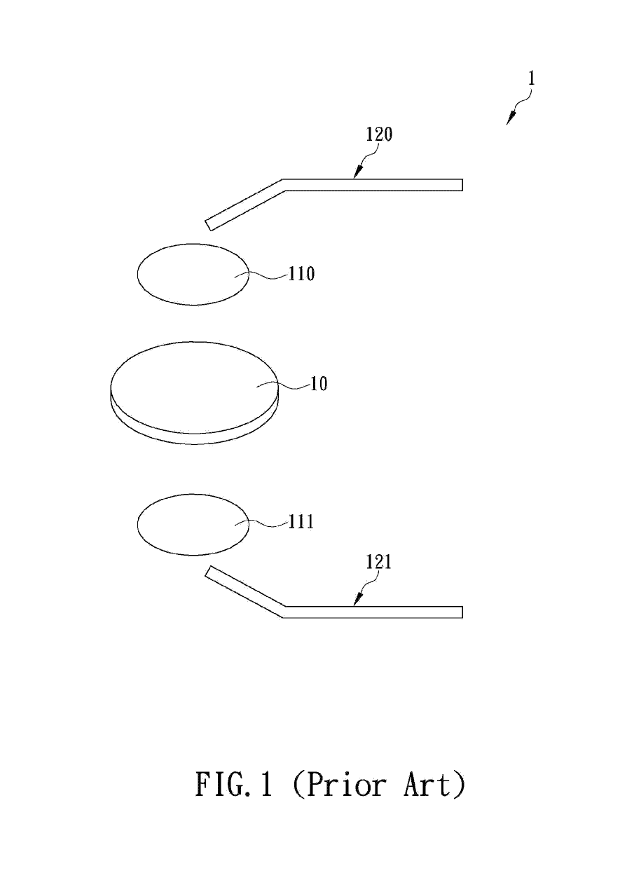

FIG. 2 is an assembled cutaway view of the conventional surge protector shown in FIG. 1;

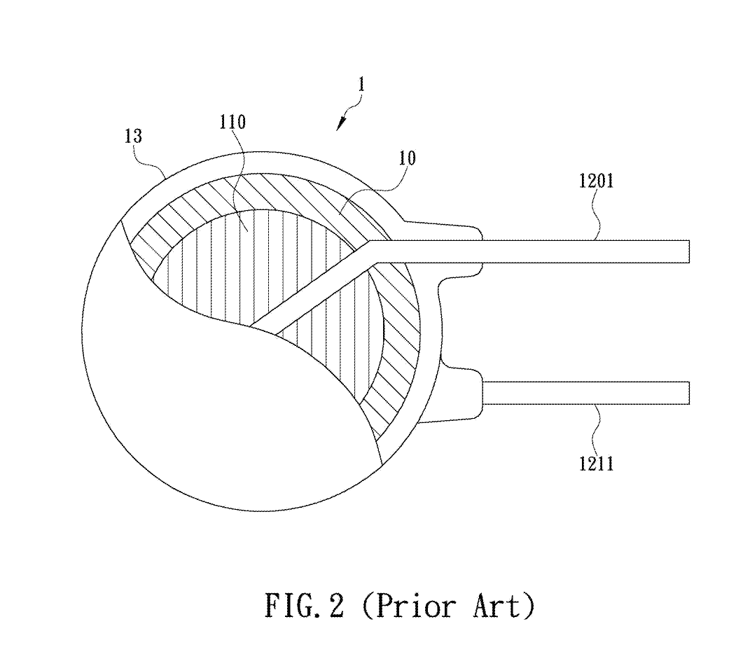

FIG. 3 schematically shows a circuit in which the conventional surge protector shown in FIG. 1 and FIG. 2 is installed;

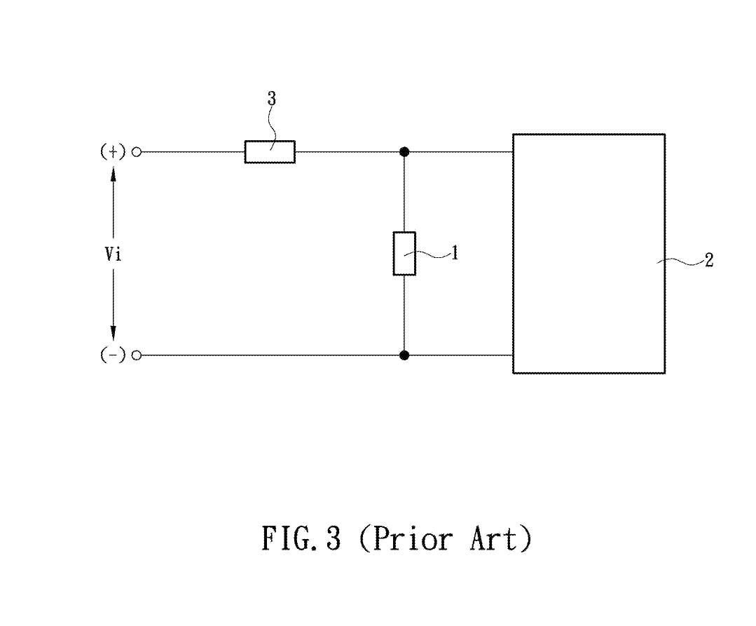

FIG. 4 is an assembled cutaway view of another conventional surge protector;

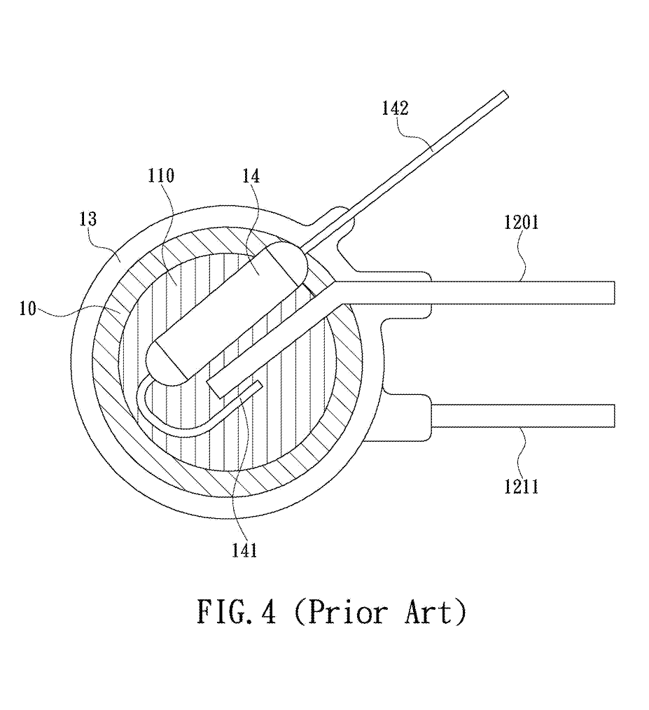

FIG. 5 is an assembled cutaway view of the first preferred embodiment of the present invention; and

FIG. 6 schematically shows the first conductive plate in the second preferred embodiment of the present invention.

### DETAILED DESCRIPTION OF THE INVENTION

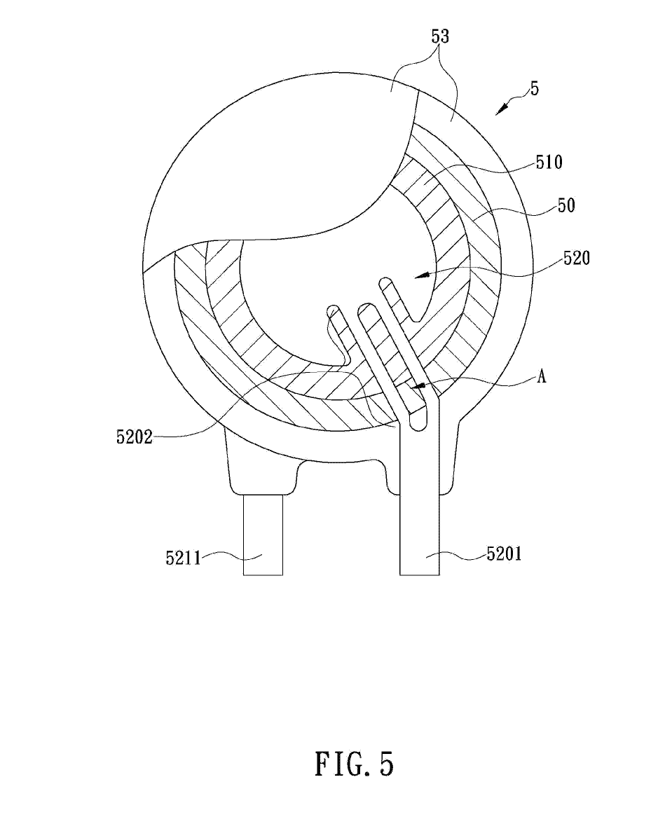

The present invention provides a surge protector having a safety mechanism. The surge protector is applicable to the power supply end of an electronic apparatus. Referring to FIG. 5 for the first preferred embodiment of the present invention, the surge protector 5 includes a dielectric element 50, a first conductive plate 520, a second conductive plate (not shown), and an insulating enclosure 53. The dielectric element 50 is a plate made of a polycrystalline semiconductor ceramic material. The dielectric element 50 has two opposite sides respectively attached with a first electrode 510 and a second electrode (not shown). A portion of the first conductive plate 520 that is adjacent to one end (hereinafter referred to as the first end) of the first conductive plate 520 is attached to the first electrode 510 via surface contact. The opposite end of the first conductive plate 520 serves as a first pin 5201 for electrically connecting with the power supply end of an electronic apparatus (not shown). Between the two ends of the first conductive plate 520 is a middle section 5202 whose cross-sectional area is smaller than those of the other sections of the first conductive plate 520. The middle section 5202 provides a fuse-like mechanism because it melts and breaks when subjected to a large current that generates a high temperature exceeding a predetermined threshold value. Similarly, a portion of the second conductive plate that is adjacent to one end (hereinafter referred to as the first end) of the second conductive plate is attached to the second electrode via surface contact. The opposite end of the second conductive plate serves as a second pin 5211 for electrically connecting with the power supply end of the electronic apparatus. The second conductive plate also has a middle section between its two ends, wherein the cross-sectional area of this middle section is smaller than those of the other sections of the second conductive plate. The middle section of the second conductive plate will melt and break if a large current flows through this section and generates a high temperature exceeding a predetermined threshold value. Thus, the middle section of the second conductive plate also provides a fuse-like mechanism. The insulating enclosure 53 encloses the dielectric element 50, the first conductive plate 520, and the second conductive plate in such a way that the middle section 5202 of the first conductive plate 520 and the middle section of the second conductive plate are both enclosed and that only the first pin 5201 and the second pin 5211 are exposed from the insulating enclosure 53.

When the high voltage of a rush current flowing through the surge protector 5 causes the portion of the first conductive plate 520 that is adjacent to its first end to separate from the first electrode 510, or when the high voltage punches through the dielectric element 50, causing an extremely large transient current to pass through the surge protector 5 and generate an extremely high temperature, the middle section 5202 of the first conductive plate 520 breaks immediately because of the extremely large transient current or the extremely high temperature and forms an open circuit to protect the electronic apparatus. Thus, the surge protector 5 is kept from burning which may otherwise result from continuous accumulation of heat, and the electronic apparatus or its electronic circuits or elements are thereby protected from damage.

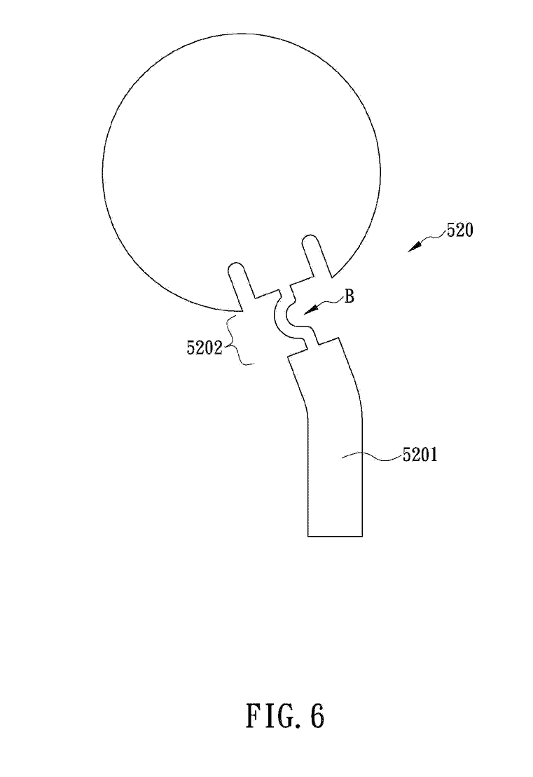

In the first preferred embodiment as shown in FIG. 5, the middle section 5202 of the first conductive plate 520 (and/or the middle section of the second conductive plate) is formed with at least one slot A. The slot A penetrates the middle section 5202 in order for the cross-sectional area of the middle section 5202 to be smaller than the cross-sectional areas of the other sections of the first conductive plate 520. While the slot A in the first preferred embodiment is formed within the middle section 5202 of the first conductive plate 520 (and/or the middle section of the second conductive plate), the present invention is not limited to this configuration. In the second preferred embodiment of the present invention as shown in FIG. 6, the slot B can be formed at either lateral side of the middle section 5202 of the first conductive plate 520 (and/or the middle section of the second conductive plate) as a way to reduce the cross-sectional area of the middle section 5202 in comparison with the cross-sectional areas of the other sections of the same conductive plate.

In the foregoing preferred embodiments of the present invention, the first conductive plate 520 (and/or the second conductive plate) is made of a conductive metal having a lower melting point and higher impedance than copper. This conductive metal can be aluminum, silver, tin, zinc, or an alloy thereof, provided that an extremely large transient current running through the middle section 5202 of the first conductive plate 520 can generate a high temperature at the middle section 5202 due to the relatively small cross-sectional area of the middle section 5202 and thereby melt and break the middle section 5202 rapidly to form an open circuit.

In other preferred embodiments of the present invention, with a view to increasing the area of electrical conduction between the first conductive plate 520 and the first electrode 510 (and/or the second conductive plate and the second electrode), the portion of the first conductive plate 520 that is adjacent to its first end and attached to the first electrode 510 (and/or the equivalent portion of the second conductive plate) has a larger surface area than the remaining portion of the same conductive plate.

The present invention is so designed that, without using additional safety elements, a surge protector with a safety mechanism, such as the surge protector 5, can be mass-produced based on the simple and low-cost structures disclosed in the foregoing embodiments. Should the connection between either electrode (e.g., the first electrode 510) and the corresponding conductive plate (e.g., the first conductive plate 520) break, or should through holes be formed in the resistor body of the dielectric element 50, the surge proctor 5 forms an open circuit as soon as the high temperature generated by the large current through the middle section 5202 of the first conductive plate 520 melts and breaks the middle section 5202. The open circuit ensures that the electronic apparatus protected by the surge protector 5 is safe from damage which may otherwise result from the fire incidents discussed in Description of Related Art.

While the invention herein disclosed has been described by means of specific embodiments, numerous modifications and variations could be made thereto by those skilled in the art without departing from the scope of the invention set forth in the claims.

What is claimed is:

1. A surge protector with a safety mechanism, comprising:
a dielectric element which is a plate made of a polycrystalline semiconductor ceramic material, the dielectric element having two opposite sides each attached with an electrode;
two conductive plates each having a portion which is adjacent to one end thereof and which is attached to a corresponding one of the electrodes via surface contact, each said conductive plate having an opposite end serving as a pin for electrically connecting with a power supply end of an electronic apparatus, each said conductive plate having a middle section between the two ends thereof, wherein the middle section of at least one of the conductive plates has a smaller cross-sectional area than other sections of the conductive plate so that, when subjected to a large current generating a high temperature exceeding a predetermined threshold value, the middle section melts and breaks to provide a fuse-like mechanism; and
an insulating enclosure enclosing the dielectric element and the conductive plates in such a way that the middle section of each said conductive plate is enclosed and that only the pins are exposed from the insulating enclosure.

2. The surge protector of claim 1, wherein the conductive plates are made of a conductive metal having a lower melting point and higher impedance than copper in order for a large current flowing through the middle section with the smaller cross-sectional area to generate the high temperature at the middle section because of the smaller cross-sectional area and thereby melt and break the middle section, the conductive metal being selected from the group consisting of aluminum, silver, tin, zinc, and alloys thereof.

3. The surge protector of claim 2, wherein the middle section with the smaller cross-sectional area is formed with and penetrated by at least one slot in order to have the smaller cross-sectional area.

4. The surge protector of claim 3, wherein the slot is formed within the middle section with the smaller cross-sectional area.

5. The surge protector of claim 3, wherein the slot is formed at a lateral side of the middle section with the smaller cross-sectional area.

6. The surge protector of claim 4, wherein the portion of each said conductive plate that is adjacent to the one end thereof and is attached to the corresponding one of the electrodes has a larger surface area than other portions of the each said conductive plate in order to increase an area of electrical conduction between each said conductive plate and the corresponding one of the electrodes.

7. The surge protector of claim 5, wherein the portion of each said conductive plate that is adjacent to the one end thereof and is attached to the corresponding one of the electrodes has a larger surface area than other portions of the each said conductive plate in order to increase an area of electrical conduction between each said conductive plate and the corresponding one of the electrodes.
